(19) United States
(12) Patent Application Publication
(10) Pub. No.: US 2024/0005274 A1
(43) Pub. Date: Jan. 4, 2024

(54) PART PREPARATION SYSTEM, PART PREPARATION DEVICE, AND PROGRAM

(71) Applicant: ORGANO CORPORATION, Tokyo (JP)

(72) Inventors: Fumio SUDO, Tokyo (JP); Toyokazu KOBAYASHI, Tokyo (JP); Masashi FUJITA, Tokyo (JP); Kazume HIRAO, Tokyo (JP)

(73) Assignee: ORGANO CORPORATION, Tokyo (JP)

(21) Appl. No.: 18/034,467

(22) PCT Filed: Oct. 5, 2021
(86) PCT No.: PCT/JP2021/036776

§ 371 Date: Apr. 28, 2023

(30) Foreign Application Priority Data
Oct. 30, 2020 (JP) 2020-182516

(51) Int. Cl. G06Q 10/0875; G06Q 10/083

(52) U.S. Cl. CPC G06Q 10/0875; G06Q 10/083

(57) ABSTRACT

A database stores inventory status information indicating the inventory status of parts and delivery status information indicating the delivery status of the parts, and a part preparation device acquires part identification information indicating a part that is needed, required quantity information indicating the quantity of parts needed, and required timing information indicating when the part is needed, and selects a securement site for securing the required part based on the part identification information, required quantity information, required timing information that were acquired, as well as on inventory status information and delivery status information that are stored in the database.

### TECHNICAL FIELD

This invention relates to a part preparation system, a part preparation device and a program.

### BACKGROUND OF ART

In recent years, a device has been considered for supporting maintenance work when an alarm is activated by a water treatment apparatus, the device providing support by checking the inventory of necessary parts and preparing for transportation of the parts based on the content of the activated alarm (See, e.g., Patent Document 1).

### PRIOR ART DOCUMENTS

### Patent Documents

Patent Document 1: Patent No. JP6617786

### SUMMARY OF THE INVENTION

### Problem to be Solved by the Invention

In the technology described above, the parts to be prepared can only be secured by the inventory held at a given securement location. In other words, it is not possible to respond immediately when there is no inventory at that securement location. This makes it difficult to secure parts flexibly when parts are needed.

The purpose of the present invention is to provide a part preparation system, a part preparation device, and a program that can flexibly secure parts when parts are needed.

### Means for Solving the Problem

The present invention is a part preparation system, comprising:
a database; and
a part preparation device, wherein
the database stores inventory status information indicating the inventory status of parts and delivery status information indicating the delivery status of the parts,
the part preparation device comprises:
a preparation information acquisition unit that acquires part identification information indicating a required part, required quantity information indicating quantity of the required part, and required timing information indicating a time when the part is required; and
a selection unit that selects a securement site for securing the required part based on the part identification information, the required quantity information, and the required timing information that were acquired by the preparation information acquisition unit, as well as on the inventory status information and the delivery status information that are stored in the database.

Further, the present invention is a part preparation device, comprising:
a preparation information acquisition unit that acquires part identification information indicating a required part, required quantity information indicating quantity of the required part, and required timing information indicating a time when the part is required; and
a selection unit that selects a securement site for securing the required part based on the part identification information, the required quantity information, and the required timing information that were acquired by the information acquisition unit, as well as on inventory status information indicating inventory status of parts and delivery status information indicating delivery status of parts that are stored in a database.

Further, the present invention is a program for causing a computer to execute procedures, the procedures comprising:
a procedure for acquiring part identification information indicating a required part, required quantity information indicating quantity of the required part, and required timing information indicating a time when the part is required; and
a procedure for selecting a securement site for securing the required part based on the part identification information, the required quantity information that were acquired, as well as on required timing information, and inventory status information indicating inventory status of the part and delivery status information indicating delivery status of parts that are stored in a database.

### Advantageous Effects of the Invention

In this invention, when parts are needed, the parts can be flexibly secured.

### BRIEF DESCRIPTION OF THE DRAWINGS

FIG. 1 is a diagram showing a first embodiment of the part preparation system of the present invention.

FIG. 2 is a diagram showing an example of the internal configuration of the part preparation device shown in FIG. 1.

FIG. 3 is a diagram showing an example of inventory status information stored in the database shown in FIG. 1.

FIG. 4 is a diagram showing an example of delivery status information stored in the database shown in FIG. 1.

FIG. 5A is a flowchart for illustrating an example of the part preparation method in the part preparation device shown in FIG. 1.

FIG. 5B is a flowchart for illustrating an example of the part preparation method in the part preparation device shown in FIG. 1.

FIG. 5C is a flowchart for illustrating an example of the part preparation method in the part preparation device shown in FIG. 1.

FIG. 6 is a diagram showing a second embodiment of the part preparation system of the present invention.

FIG. 7 is a diagram showing an example of the internal configuration of the part preparation device shown in FIG. 6.

FIG. 8A is a flowchart for illustrating an example of the part preparation method in the part preparation device shown in FIG. 6.

FIG. 8B is a flowchart for illustrating an example of the part preparation method in the part preparation device shown in FIG. 6.

FIG. 8C is a flowchart for illustrating an example of the part preparation method in the part preparation device shown in FIG. 6.

FIG. 8D is a flowchart for illustrating an example of the part preparation method in the part preparation device shown in FIG. 6.

FIG. 9 is a diagram showing an example of a display at a notified destination that was notified of the scheduled time of acquisition of parts in Step S34.

### DESCRIPTION OF THE EMBODIMENTS

The following is a description of embodiments of the invention with reference to the drawings.

### First Embodiment

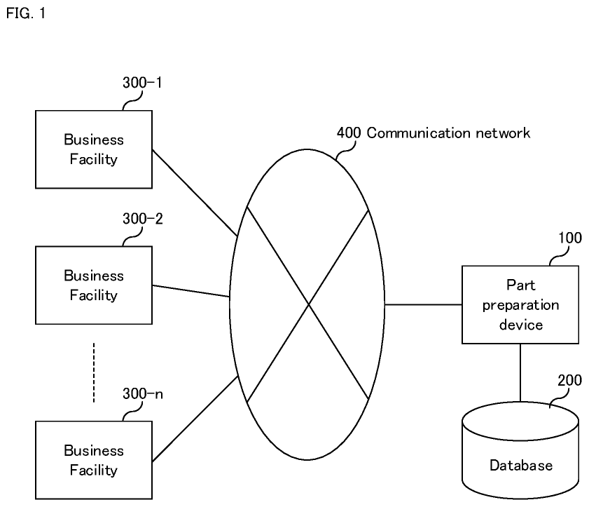

FIG. 1 is a diagram showing a first embodiment of the part preparation system of the present invention. As shown in FIG. 1, this embodiment comprises part preparation device 100, database 200, and business facilities 300-1 to 300-n (n is a natural number). Part preparation device 100 and database 200 may be directly connected. Part preparation device 100 and database 200 may be connected via communication network 400. Part preparation device 100 and database 200 may be connected via radio. Part preparation device 100 and database 200 may be connected via wiring. Part preparation device 100 and each of business facilities 300-1 to 300-n may be directly connected to each other. Part preparation device 100 and each of business facilities 300-1 to 300-n may be connected via communication network 400. Part preparation device 100 and each of business facilities 300-1 to 300-n may be connected via radio. Part preparation device 100 and each of business facilities 300-1 to 300-n may be connected to each other via wiring. Communication network 400 is a telecommunication line that can send and receive electrical signals carrying information. Communication network 400 is, for example, a telephone line or the Internet. Communication network 400 enables telephone calls, facsimile communications, sending and receiving e-mail, and wireless communications. Business facilities 300-1 to 300-n are facilities that use the parts to be prepared. Business facilities 300-1 to 300-n may be entities such as factories, systems, modules, series, and devices that are installed in a factory, that can be managed as a unit, and that use parts that are to be prepared. Business facilities 300-1 to 300-n themselves need not be communicatively connected to other devices such as communication network 400 or part preparation device 100 (i.e., are not equipped with communication functions). In such a case, communication devices are provided for each of business facilities 300-1 to 300-n and manage each of business facilities 300-1 to 300-n. Each of these communication devices is communicably connected to other devices such as communication network 400 and part preparation device 100. In the following explanation, business facilities 300-1 to 300-n are described as carrying out communication and include cases in which communication is performed by these communication devices.

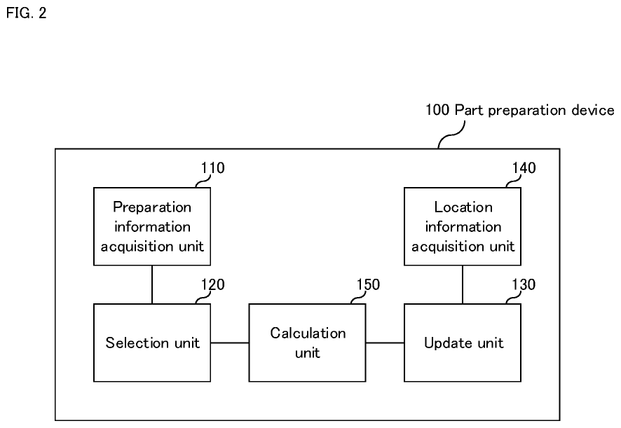

FIG. 2 is a diagram showing an example of the internal configuration of part preparation device 100 shown in FIG. 1. As shown in FIG. 2, part preparation device 100 shown in FIG. 1 comprises preparation information acquisition unit 110, selection unit 120, update unit 130, location information acquisition unit 140, and calculation unit 150. FIG. 2 shows, of the constituent elements of part preparation device 100 shown in FIG. 1, the main elements in this embodiment.

Preparation information acquisition unit 110 acquires part identification information, required quantity information, and required timing information from business facilities 300-1 to 300-n. Part identification information indicates the required parts. Required quantity information indicates the quantity of these required parts. Required timing information indicates when the parts are needed. Preparation information acquisition unit 110 is equipped with a communication function. Preparation information acquisition unit 110 receives and acquires part identification information, required quantity information, and required timing information transmitted from business facilities 300-1 to 300-n. The parts are components used in a water treatment apparatus. Parts can be, for example, pumps, valves, piping materials, electrical instrumentation, and consumables such as ion exchange resins, EDI (ElectroDelonization, or continuous ion exchange), reverse osmosis membranes, ultrafiltration membranes, filters, activated carbon, and filter media.

Selection unit 120 selects a securement site to secure the required parts based on the part identification information, required quantity information, and required timing information acquired by preparation information acquisition unit 110, as well as on inventory status information and delivery status information stored in database 200. Furthermore, selection unit 120 selects, in the database, a facility or a holder that is to secure the necessary parts based on delivery status information and inventory status information that are associated with the facility identification information assigned to a facility other than the facility from which preparation information acquisition unit 110 acquired part identification information, required quantity information, and required timing information. At this time, selection unit 120 selects the facility or holder that is to be the securement site that is to secure the necessary parts based on facility location information, acquisition time information, usage time information, acquisition quantity information, inventory location information, and inventory quantity information stored in database 200 as delivery status information.

Location information acquisition unit 140 acquires existence location information indicating the locations of existence of the parts for which each facility is preparing to acquire. This location information indicates where the prepared parts are currently located. This location information may, for example, be information indicating the current position of a vehicle or vessel used as the means of transportation if the part is in transit. This location information may also be, for example, information indicating the location of a manufacturing plant if the part is being manufactured. Location information should be information that allows recognition of the current location of the part. Location information may be, for example, information acquired using the Global Positioning System (GPS) function. Location information can be, for example, the location information of a communication terminal possessed by a transporter of the component, which is acquired by a wireless base station. Location information may also be, for example, information based on transit information acquired by a predetermined process such as a transit check performed by a transporter at a transit point through which the transporter passes during the transportation of parts.

Update unit 130 updates information stored in database 200. If database 200 stores existence location information, update unit 130 updates existence location information stored in database 200 based on existence location information acquired by location information acquisition unit 140. Update unit 130 updates the information stored in database 200 based on the results calculated by calculation unit 150.

When selection unit 120 selects a facility as a securement site that is to secure parts, calculation unit 150 calculates a quantity obtained by subtracting the quantity indicated by required quantity information acquired by preparation information acquisition unit 110 from the quantity of parts to be acquired by the facility which is indicated by acquisition quantity information stored in database 200 for the facility selected by selection unit 120. When selection unit 120 selects a holder as the securement site that is to secure the parts, calculation unit 150 calculates a quantity obtained by subtracting the quantity indicated by required quantity information acquired by preparation information acquisition unit 110 from the quantity of parts indicated by inventory quantity information stored in database 200.

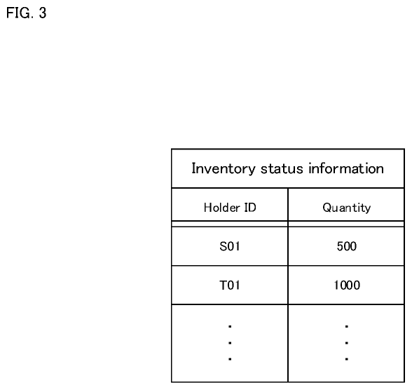

Database 200 stores inventory status information and delivery status information. Inventory status information indicates the inventory status of parts. Delivery status information indicates the delivery status of the parts. Database 200 may be created using general-purpose software such as spreadsheet software that stores the correspondence of multiple pieces of information. Database 200 may be created, for example, using proprietary and specialized software. Database 200 created in this way is stored in a storage medium such as a personal computer (PC), server, cloud, or memory. FIG. 3 is a diagram showing an example of inventory status information stored by the database shown in FIG. 1. As shown in FIG. 3, inventory status information stored by database 200 shown in FIG. 1 is information that places holders' IDs in association with quantities. A holder's ID is holder identification information uniquely assigned in advance to manufacturers of parts to be prepared and to suppliers such as intermediaries and service providers who supply parts to business facilities 300-1 to 300-n. Quantity is inventory quantity information, which is the quantity of parts held by the holder assigned the holder's ID. The unit of quantity is based on the part. For example, if the part is an ion exchange resin, the unit of quantity is “L (liter).” If the part is, for example, a reverse osmosis membrane, the unit of quantity is “units.” This holder's ID and quantity are stored in database 200 as inventory status information for each part.

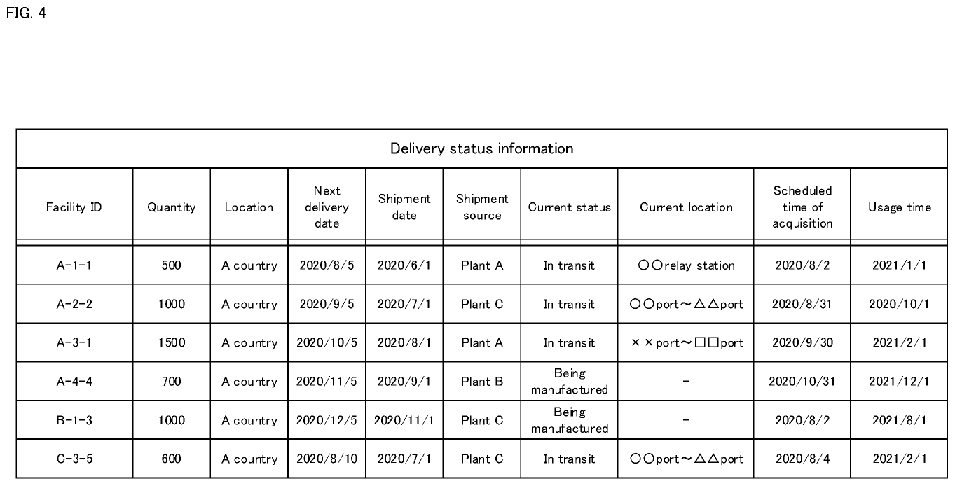

FIG. 4 is a diagram showing an example of delivery status information stored by the database shown in FIG. 1. As shown in FIG. 4, the delivery status information stored by database 200 shown in FIG. 1 is information that places in association facility IDs, quantities, locations, next delivery dates, shipment dates, shipment sources, current statuses, current locations, acquisition times, and usage times. The facility ID indicates the facility identification information assigned in advance to each of business facilities 300-1 to 300-n. The facility ID, for example, consists of letters of the alphabet and numbers, as shown in FIG. 4. In this case, the first letter may indicate a customer code, and the numbers that follow may indicate a more detailed classification of the office, plant, facility, etc. owned by the customer. Quantity indicates acquisition quantity information indicating the quantity of parts that have been prepared and acquired or that will be acquired by the facility to which the facility ID is assigned. The unit of quantity is based on the part. For example, if the part is an ion exchange resin, the unit of quantity is “L (liter).” If the part is a reverse osmosis membrane, the unit of quantity is “unit.” Location indicates facility location information that indicates the location where the facility to which the facility ID is assigned is installed. The location may be the name of a country. The location may also be the name or address of a community. The next delivery date indicates the date when the facility to which the facility ID is assigned will next acquire the relevant part. The shipment date indicates the date when the parts that the acquiring facility identified by the facility ID are scheduled to be shipped from the source. The shipment source indicates the shipment source that is to ship parts that the facility conferred the facility ID is scheduled to acquire. The shipment source may be the name of a country. The shipment source may be a local name or address, the name of a factory, or the name of a supplier. The current status indicates the current status of the prepared parts. The current location is existence location information indicating the current location of the part when the current status is “in transit.” This current location is updated by update unit 130 based on existence location information acquired by location information acquisition unit 140. The updating of the current location by update unit 130 may be performed according to the time at which location information acquisition unit 140 acquires existence location information. The updating of the current location by update unit 130 may be performed in accordance with the time of a change in existence location information acquired by location information acquisition unit 140. Database 200 does not have to store the current location. The acquisition time is acquisition time information that indicates when the facility to which the facility ID is assigned is to acquire the relevant part. The acquisition time indicates the date when the part is expected to be acquired. The acquisition time may be updated (changed) by update unit 130 depending on the circumstances. The usage time is usage time information that indicates when the facility assigned the facility ID will start using the acquired part. The usage time indicates the date when use of the part starts. The usage time may be updated (changed) by update unit 130 depending on the circumstances. Such correspondence is stored in database 200 as delivery status information for each part.

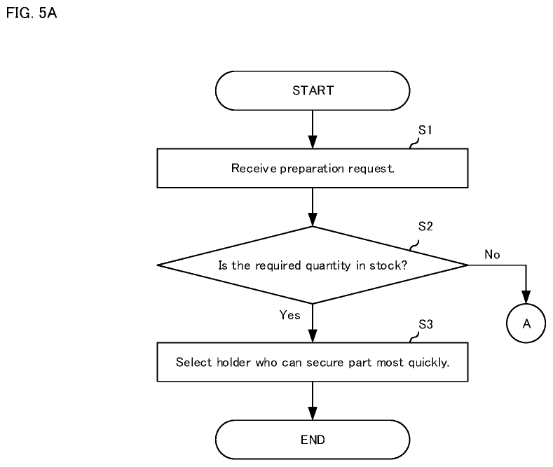

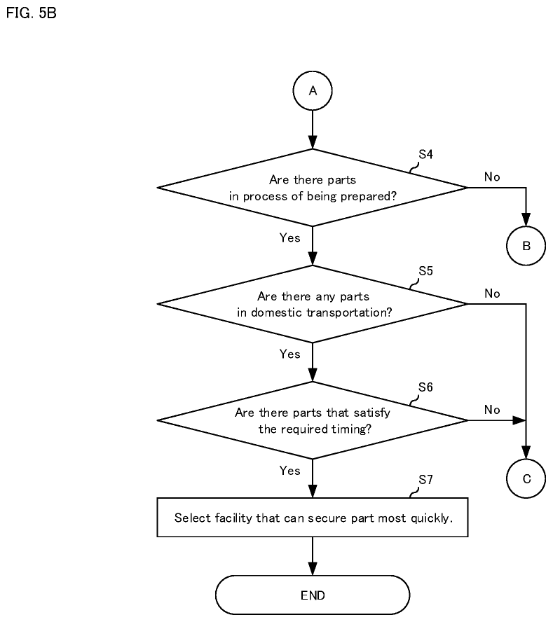

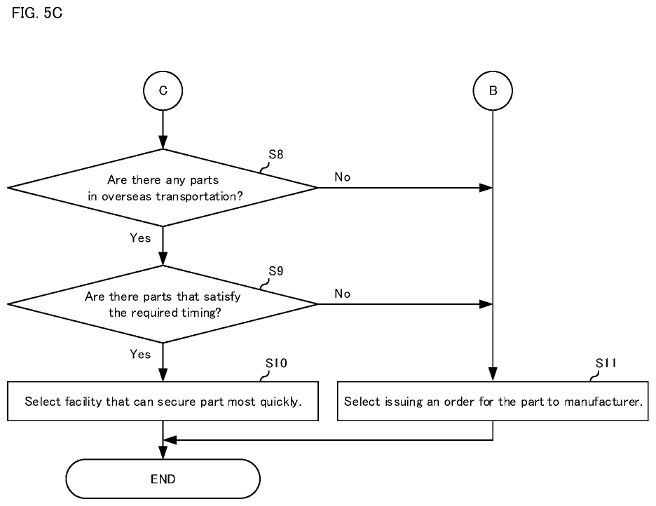

The part preparation method in part preparation system 100 shown in FIG. 1 is described below. FIGS. 5A to 5C are flowcharts for illustrating an example of the part preparation method in part preparation device 100 shown in FIG. 1.

First, preparation information acquisition unit 110 acquires a preparation request for a part (Step S1). Preparation information acquisition unit 110 receives and acquires preparation requests for parts sent from business facilities 300-1 to 300-n. In the event of a sudden failure, etc., of a part in business facilities 300-1 to 300-n, it is necessary to procure a replacement part for the relevant part. In such a case, a preparation request is sent from an business facility of business facilities 300-1 to 300-n to part preparation device 100 via communication network 400 to request preparation of the relevant part. This preparation request includes part identification information, required quantity information, and required timing information. Part identification information is assigned in advance to each required part to identify the relevant part. Required quantity information indicates the quantity of parts needed. Required timing information indicates when a part for which preparation was requested is required (to be replaced) at the relevant business facility of business facilities 300-1 to 300-n.

When preparation information acquisition section 110 acquires a preparation request for a part, selection unit 120 searches for a holder who has in stock the part indicated by the part identification information included in the preparation request in at least the quantity indicated by part quantity information based on inventory status information stored in database 200 (Step S2). Specifically, selection unit 120 searches the inventory status information stored in database 200 for holders who have in stock the part indicated by the part identification information included in the preparation request acquired by preparation information acquisition unit 110. Selection unit 120 then searches the stock status information stored in database 200 for holders who have the relevant part in stock in excess of the quantity indicated by the part quantity information included in the preparation request acquired by preparation information acquisition unit 110. Selection unit 120 then selects the holder that was retrieved as the securement site. If a plurality of holders can be retrieved at this time, selection unit 120 may select as the securement site the holder that can secure the part most quickly from among the holders that could be retrieved (Step S3). In this case, the locations of the holders are stored in database 200 along with the holders' IDs, and selection unit 120 selects from among the holders that could be retrieved the holder that either is closest to the business facility of business facilities 300-1 to 300-n that sent the preparation request or that can supply the part most quickly to the business facility of business facilities 300-1 to 300-n that sent the preparation request. The conditions that should be prioritized, such as the speed of supply of a part or the travel distance required to secure and supply the part, can be freely determined.

If selection unit 120 in Step S2 was unable to retrieve from inventory status information stored in database 200 a holder who has in stock the part indicated by the part identification information included in a preparation request acquired by preparation information acquisition unit 110, selection unit 120 determines whether or not the part indicated by the part identification information included in the preparation request acquired by preparation information acquisition unit 110 is in the process of being prepared based on the delivery status information stored in database 200 (Step S4). Here, if the part indicated by part identification information included in the preparation request acquired by preparation information acquisition unit 110 is included in delivery status information stored in database 200, the part is being prepared. When a part indicated by part identification information included in a preparation request acquired by preparation information acquisition unit 110 is being prepared, selection unit 120 determines based on delivery status information stored in database 200 whether there is a business facility stored in database 200 whose quantity of parts being arranged is greater than or equal to the quantity indicated by part quantity information included in the preparation request acquired by preparation information acquisition unit 110. For example, using the example shown in FIG. 4, if the quantity of a part indicated by part quantity information is 1000 for the part indicated by the part identification information included in a preparation request acquired by preparation information acquisition unit 110 and the quantities of the relevant part being prepared by facility IDs “A-2-2,” “A-3-1,” and “B-1-3” shown in FIG. 4 are “1000,” “1500,” and “1000,” respectively, then the facilities that have been conferred facility IDs “A-2-2,” “A-3-1,” and “B-1-3” are the facilities that satisfy the part quantity information included in the preparation request.

If selection unit 120 determines in Step S4 that there are facilities that satisfy the preparation request, selection unit 120 then searches among these facilities for one whose parts are currently in domestic transportation, that is, one whose parts have arrived in Japan (Step S5). Selection unit 120 makes this determination based on the current locations contained in delivery status information stored in database 200. If database 200 does not store the current locations, selection unit 120 performs the process of Step S5 based on the existence location information acquired by location information acquisition unit 140. If selection unit 120 is able to retrieve information for parts that are in domestic transportation, selection unit 120 then searches for parts that satisfy the required timing as indicated by required timing information contained in the preparation request acquired by preparation information acquisition unit 110 (Step S6). Specifically, selection unit 120 searches database 200 for parts for which the acquisition times that are associated with facility IDs of facilities that have made preparations for parts currently in domestic transport are earlier than the time when the parts are needed as indicated by required timing information included in the preparation request acquired by preparation information acquisition section 110. At this time, selection unit 120 takes into consideration the time required to transport the relevant parts to the facility that made the preparation request from the current locations of the target parts for which facilities that are securement sites have made preparations, and selects the optimal facility to secure the part. Selection unit 120 then selects the facility that can secure the parts most quickly as the securement site from among the facilities that were retrieved (Step S7).

On the other hand, if no parts are currently being transported domestically in Step S5, or if no parts satisfy the required timing as indicated by the required timing information included in the preparation request in Step S6, selection unit 120 searches for parts that have been prepared by facilities that selection unit 120 determined as satisfying the preparation request in Step S4 but that are currently in transportation overseas based on the delivery status information stored in database 200 (Step S8). In the processing of this Step S8, similar to the processing of Step S5, selection unit 120 makes a determination based on the current location contained in delivery status information stored in database 200. If selection unit 120 is able to retrieve parts that are in overseas transportation, selection unit 120 searches for parts that satisfy the timing of need as indicated by the required timing information contained in the preparation request acquired by preparation information acquisition unit 110 (Step S9). In this processing of Step S9, similar to the processing of Step S6, selection unit 120 searches database 200 for parts that are in overseas transportation but for which acquisition times associated with facility IDs of facilities that have made preparations are earlier than the time when the parts are needed as indicated by required timing information included in the preparation request acquired by preparation information acquisition section 110. At this time, selection unit 120 takes into consideration the time required to transport the relevant parts from the current locations of the target parts for which preparations have been made by facilities that are to be securement sites to the facility that made the preparation request and selects the optimal facility to secure the part. Selection unit 120 then selects the facility that can secure the parts most quickly as the securement site from among the facilities that were retrieved (Step S10).

On the other hand, if selection unit 120 determines in Step S4 that there is no facility that satisfies the preparation request, or was unable in Step S8 to retrieve from the delivery status information stored in database 200 a part that is currently in transport overseas that was prepared by a facility that satisfies the preparation request, or was unable in Step S9 to retrieve from delivery status information stored in database 200 a part that satisfies the required timing information contained in the preparation request, selection unit 120 selects issuing an order for the part to the manufacturer (maker) that produces the part (Step S11).

When selection unit 120 subsequently selects a facility as the securement site for securing the parts, calculation unit 150 calculates a quantity obtained by subtracting the quantity indicated by the required quantity information acquired by preparation information acquisition unit 110 from the quantity of parts to be acquired by the facility selected by selection unit 120, which is included in the delivery status information stored by database 200. When selection unit 120 has selected a holder as the securement site to secure parts, calculation unit 150 calculates a quantity obtained by subtracting the quantity indicated by the required quantity information acquired by preparation information acquisition unit 110 from the quantity of parts in stock contained in inventory quantity information that is stored in database 200. Update unit 130 updates information stored in database 200 based on the results calculated by calculation unit 150. For example, if selection unit 120 secures a quantity of “1200” parts from “1500” parts that have been prepared (to be acquired) by the facility whose facility ID is “A-3-1” in the delivery status information stored in database 200 shown in FIG. 4, calculation unit 150 subtracts “1200” from “1500.” Update unit 130 then updates the quantity of parts prepared (to be acquired) by the facility whose facility ID is “A-3-1” stored in database 200 to “300,” which is the numerical value resulting from the subtraction performed by calculating unit 150.

Selection unit 120 may select a plurality of facilities and holders as securement sites. For example, if the required quantity of a part indicated by required quantity information contained in the preparation request is “1500,” “1000” parts may be secured from the parts to be acquired that have been prepared by one facility and “500” parts may be secured from the parts to be acquired that have been prepared by one other facility. In such cases, the mutual ratio of the quantity of parts to be secured from a plurality of facilities is not specified. For example, the ratio of the quantity of parts to be secured from multiple facilities with respect to each other may be set according to a weighting that is assigned to each facility in advance. Selection unit 120 may also secure the shortfall quantity resulting from securing from one facility by supplementing it with a quantity from another facility.

In the process described above, the search for securement sites was conducted in the order of holders' inventories, securement sites in domestic transportation, and securement sites in overseas transportation, but the order is not limited to this example. For example, even if the part is in overseas transportation, if the part is currently located closer in distance to the facility that sent the preparation request than to parts in domestic transportation, selection unit 120 may select the facility that has prepared (or that will acquire) the part in overseas transportation as the securement site.

Thus, in this embodiment, when a part that makes up a facility needs to be replaced, the part preparation device selects as the securement site for securing the part a holder that has the part in its inventory or selects another facility that has already made preparations to acquire the part. The database stores information such as the quantities, the use times, the times of acquisition, and the current locations in transport of parts that are held by holders or parts that are scheduled to be obtained by other facilities that have made preparations. The part preparation device selects a securement site based on the information stored in this database. This allows for flexible securement of parts when parts are needed.

### Second Embodiment

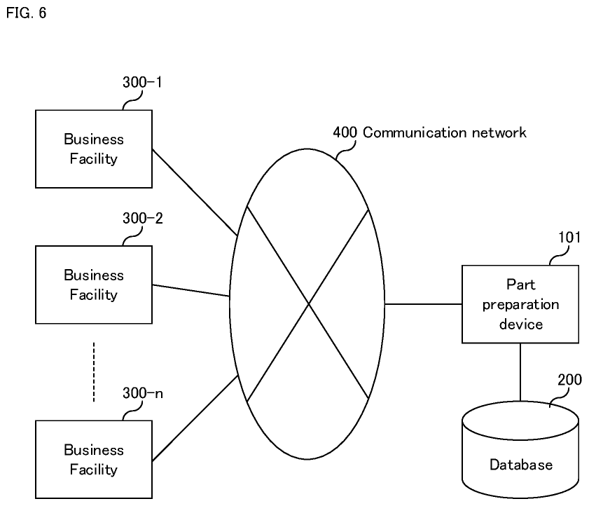

FIG. 6 is a diagram showing a second embodiment of the part preparation system of the present invention. As shown in FIG. 6, this embodiment comprises part preparation device 101, database 200, and business facilities 300-1 to 300-n (n is a natural number). Part preparation device 101 and database 200 may be directly connected. Part preparation device 101 and database 200 may be connected via communication network 400. Part preparation device 101 and database 200 may be connected via radio. Part preparation device 101 and database 200 may be connected via wiring. Part preparation device 101 and each of business facilities 300-1 to 300-n may be directly connected to each other. Part preparation device 101 and each of business facilities 300-1 to 300-n may be connected via communication network 400. Part preparation device 101 and each of business facilities 300-1 to 300-n may be connected via radio. Part preparation device 101 and each of business facilities 300-1 to 300-n may be connected to each other via wiring. Database 200, business facilities 300-1 to 300-n, and communication network 400 are each the same as those in the first embodiment.

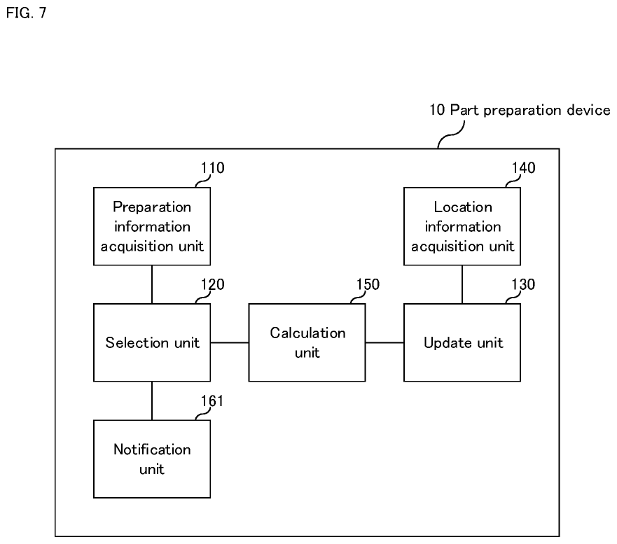

FIG. 7 is a diagram showing an example of the internal configuration of the part preparation device 101 shown in FIG. 6. As shown in FIG. 7, part preparation device 101 shown in FIG. 6 comprises preparation information acquisition unit 110, selection unit 120, update unit 130, location information acquisition unit 140, calculation unit 150, and notification unit 161. Preparation information acquisition unit 110, selection unit 120, update unit 130, location information acquisition unit 140, and calculation unit 150 are each the same as those in the first embodiment. FIG. 7 shows, of the constituent elements provided in preparation device 101 shown in FIG. 6, the principle elements in this embodiment.

Notification unit 161 provides prescribed notifications to facilities or holders selected by selection unit 120 as securement sites. In addition, notification unit 161 reports the time to acquire a part to a facility or holder selected by selection unit 120 as a securement site. Notification unit 161 reports to a facility or holder that has become a securement site, regarding the quantity of parts included in inventory status information and delivery status information stored in database 200 as updated by update unit 130, an acquisition schedule that has been prepared with the manufacturer regarding the replenishment of parts for a facility or holder that has become a securement site and whose parts quantity has decreased. This acquisition schedule includes at least the scheduled time of acquisition. This acquisition schedule may also include the quantity to be acquired. For example, if, of “1500” parts prepared by the facility with the facility ID “A-3-1” in the delivery status information shown in FIG. 4, “1000” parts have been reserved for other facilities, the quantity of parts prepared by the facility with the facility ID “A-3-1” is updated to “500.” At this time, notification unit 161 notifies the facility with facility ID “A-3-1” of the new scheduled time of acquisition of the “1000” parts reserved for other facilities.

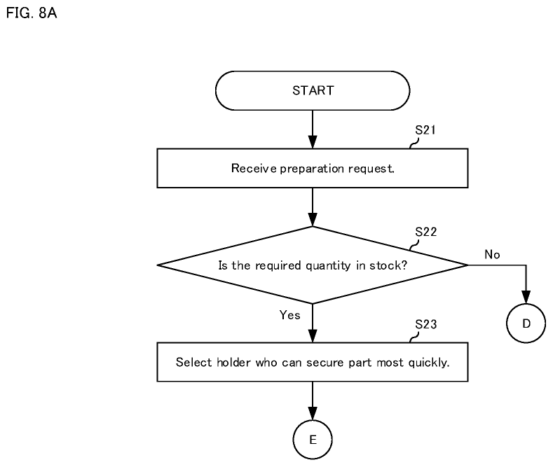

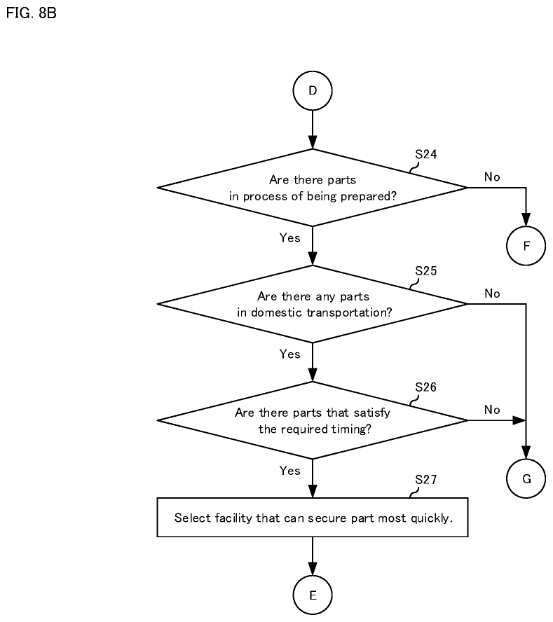

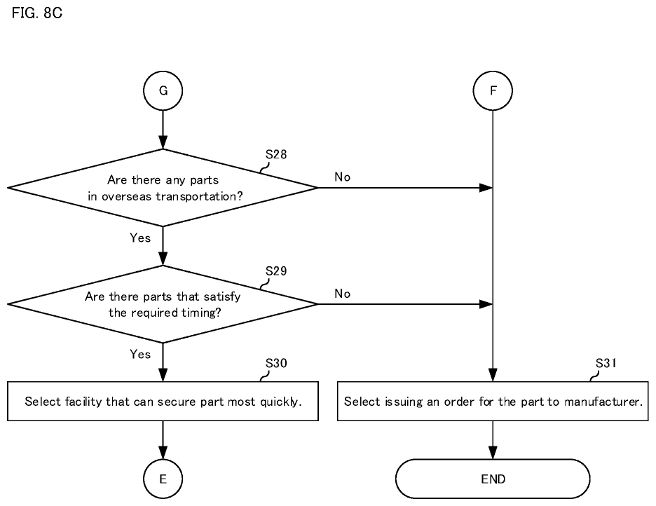

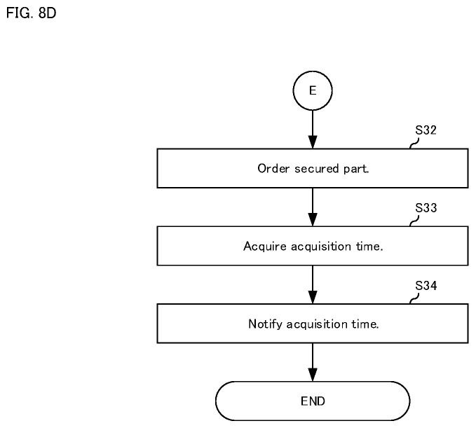

The part preparation method in part preparation device 101 shown in FIG. 6 is next described. FIGS. 8A to 8D are flowcharts for illustrating an example of the part preparation method in the part preparation device 101 shown in FIG. 6. Steps S21 to S31 in FIGS. 8A to 8C are each the same as steps S1 to 11 described using FIGS. 5A to 5C, respectively.

As in the first embodiment, if selection unit 120 selects a facility as a securement site to secure parts, calculation unit 150 calculates a quantity obtained by subtracting the quantity indicated by the required quantity information acquired by preparation information acquisition unit 110 from the quantity of parts to be acquired by the facility selected by selection unit 120, which is included in delivery status information stored by database 200. If selection unit 120 selects a holder as a securement site to secure the parts, calculation unit 150 calculates a quantity obtained by subtracting the quantity indicated by the required quantity information acquired by preparation information acquisition unit 110 from the quantity of parts in stock contained in inventory quantity information that is stored by database 200. Update unit 130 updates the information stored in database 200 based on the results calculated by calculation unit 150.

After selection unit 120 selects a securement site of parts in Step S23, Step S27, or Step S30, an order is issued for the secured quantity of parts to the supplier of the parts, such as the manufacturer (Step S32). This process may be performed automatically by part preparation device 101 or by the manager or operator of part preparation device 101. At this time, the recipient of the order, which is the supplier of the parts, is required to report the expected time of availability of the parts. Subsequently, upon receipt of the scheduled time of acquisition of the part from the supplier of the part (Step S33), notification unit 161 notifies the facility or holder selected as a securement site by selection unit 120 of the scheduled time of acquisition of the part (Step S34). In this case, the recipient of the scheduled time of acquisition of the parts from the supplier of the parts may also be part preparation device 101. Alternatively, the manager or operator of part preparation device 101 may also be the recipient of the scheduled time of acquisition of the parts from the supplier of the parts.

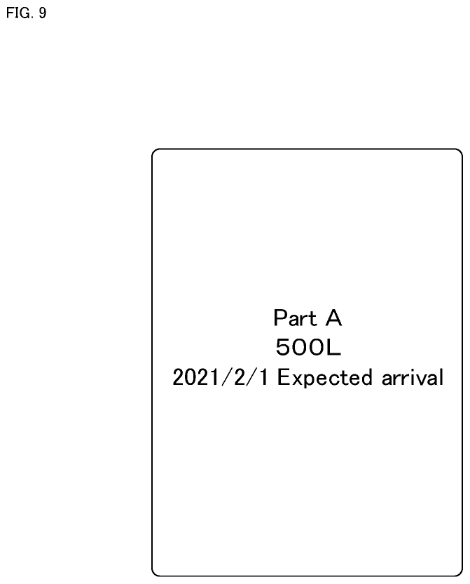

FIG. 9 is a diagram showing an example of the display at the destination of notification that was notified of the scheduled time of acquisition of parts in Step S34. As shown in FIG. 9, the display of the notified site (e.g., the display of a communication device belonging to the facility selected as the securement site) shows the name of the part, the quantity to be acquired, and the scheduled time of acquisition (arrival). In this way, when a portion of parts that have been prepared has been altered to supply another facility, the newly scheduled time of acquisition of this portion of parts can be recognized.

Update unit 130 also updates inventory status information or delivery status information stored in database 200 based on the scheduled time of acquisition and quantity to be acquired of the parts acquired by part preparation device 101. Specifically, update unit 130 reflects the scheduled time of acquisition of parts acquired by part preparation device 101 in the acquisition time that is included in delivery status information. Update unit 130 reflects the scheduled quantity of acquisition of parts acquired by part preparation device 101 in the quantity included in the inventory status information or the quantity included in delivery status information.

Selection unit 120 may select a plurality of facilities and holders as securement sites. The order in which selection unit 120 searches for the securement sites to secure parts to be prepared is not limited to any particular order. These points are described in the first embodiment.

Thus, in this embodiment, when a part that makes up a facility needs to be replaced, holders that have this part as a part in stock or other facilities that have already made preparations to acquire this part are selected as securement sites of this part. The database registers, for example, the quantities, the times of use, the acquisition times, and the current locations of transport of parts that are held by holders and parts for which other facilities have already prepared scheduled acquisition. The part preparation device selects securement sites based on the information stored in its database. This allows for the flexible securement of parts when parts are needed. In addition, facilities that are securement sites are notified of newly scheduled acquisition times when parts have been reserved for use by other facilities. In this way, the newly scheduled acquisition times of parts for which changes have occurred can be acknowledged.

When selecting securement sites to secure parts, selection unit 120 may also include among the selection conditions the amount of money to acquire the parts. For example, if there are a plurality of facilities or holders to be securement sites, selection unit 120 may select as the securement site the facility or holder that offers the lowest price to acquire the part to be secured. If, after notification unit 161 has notified a facility or holder selected by selection unit 120 as a securement site, notice should be received from the notified facility or holder that it cannot comply with the diversion of the parts being prepared, selection unit 120 may exclude that facility or holder and repeat the selection process.

Although the invention has been described above by allocating each function (process) to a respective constituent element, these assignments are not limited to those described above. In addition, as for the configuration of the constituent elements, the above-described embodiments are merely examples, and the present invention is not limited thereto.

The processing performed by each of the above-described part preparation devices 100 and 101 may be performed by logic circuits manufactured according to the purpose. Further, a computer program (hereinafter, referred to as a “program”) in which the processing contents are described as procedures may be recorded on a recording medium that can be read by part preparation devices 100 and 101, and the program recorded on the recording medium may be read into and executed by part preparation devices 100 and 101. The recording medium that can be read by part preparation devices 100 and 101 may refer to a memory or an HDD (Hard Disc Drive) such as a ROM (Read Only Memory), a RAM (Random Access Memory), or the like incorporated in part preparation devices 100 and 101, or may further refer to a transferable recording medium such as a floppy (registered trademark) disk, a magneto-optical disk, a DVD (Digital Versatile Disc), a CD (Compact Disc), a Blu-ray (registered trademark) Disc, or a USB (Universal Serial Bus) memory. The program recorded on the recording medium is read by a CPU provided in each of part preparation devices 100 and 101, and the same processing as that described above is performed under the control of the CPU. Here, the CPU operates as a computer that executes a program read from a recording medium on which the program is recorded.

While the present invention has been described with reference to the embodiments, the present invention is not limited to the above embodiments. Various changes within the scope of the present invention that will be understood by those skilled in the art can be made in the configuration and details of the present invention.

This application claims priority based on JP 2020-182516 filed on Oct. 30, 2020 and incorporates all of its disclosure herein.

1. A part preparation system, comprising:
a database; and
a part preparation device, wherein
the database stores inventory status information indicating the inventory status of parts and delivery status information indicating the delivery status of the parts,
the part preparation device comprises:
a preparation information acquisition unit that acquires part identification information indicating a required part, required quantity information indicating quantity of the required part, and required timing information indicating a time when the part is required; and
a selection unit that selects a securement site for securing the required part based on the part identification information, the required quantity information, and the required timing information that were acquired by the preparation information acquisition unit, as well as on the inventory status information and the delivery status information that are stored in the database.

2. The part preparation system according to claim 1, wherein
the database stores, as the inventory status information of the part, holder identification information indicating a holder of the part held as inventory and inventory quantity information indicating quantity of the part held as inventory by the holder indicated by the holder identification information in association with each other, and stores, as the delivery status information of the part, facility identification information assigned in advance to facilities that have prepared the part and acquisition quantity information indicating the quantity of scheduled acquisition of the part that has been prepared by the facility to which the facility identification information is assigned in association with each other; and
the selection unit selects in the database a facility or holder that is to be a securement site based on the inventory status information and the acquisition quantity information that are associated with the facility identification information assigned to facilities other than the facility that was the acquisition source of the part identification information, the required quantity information, and the required timing information that were acquired by the information acquisition unit.

3. The part preparation system according to claim 2, wherein
the part preparation device further comprises:
an update unit that updates information stored in the database; and
a location information acquisition unit that acquires existence location information indicating locations of existence of a part to be acquired by a facility, wherein
the database stores as the delivery status information for parts: the facility identification information in association with each of the acquisition quantity information, the facility location information indicating the location of facilities, acquisition time information indicating when facilities are to acquire parts, usage time information indicating when facilities are to use parts that have been acquired, and the existence location information; and
the selection unit selects a facility or holder to be a securement site based on the facility location information, the acquisition time information, the usage time information, the acquisition quantity information, the existence location information, and the inventory quantity information.

4. The part preparation system according to claim 3, wherein
the part preparation device further comprises:
a calculation unit that, when the selection unit selects a facility as the securement site, calculates a quantity obtained by subtracting a quantity indicated by the required quantity information acquired by the information acquisition unit from the quantity of parts to be acquired by the facility indicated by the acquisition quantity information for the facility that was selected by the selection unit stored in the database; and when the selection unit selects a holder as the securement site, calculates a quantity obtained by subtracting the quantity indicated by the required quantity information acquired by the information acquisition unit from the quantity of the parts indicated by the inventory quantity information stored in the database, wherein
the update unit updates information stored in the database based on the results calculated by the calculation unit.

5. The part preparation system of claim 2, wherein
the part preparation device comprises a notification unit that notifies a facility or a holder selected by the selection unit as the securement site.

6. The part preparation system according to claim 5, wherein
the notification unit notifies a facility or a holder selected by the selection unit as the securement site when to acquire the parts.

7. The part preparation system of claim 1, wherein
the information acquisition unit has a communication function and acquires information by receiving the part identification information, the required quantity information, and the required timing information transmitted from other devices connected to the part preparation device.

8. The part preparation system of claim 1, wherein
the parts are parts used in a water treatment apparatus.

9. A part preparation device, comprising:
a preparation information acquisition unit that acquires part identification information indicating a required part, required quantity information indicating quantity of the required part, and required timing information indicating a time when the part is required; and
a selection unit that selects a securement site for securing the required part based on the part identification information, the required quantity information, and the required timing information that were acquired by the information acquisition unit, as well as on inventory status information indicating inventory status of parts and delivery status information indicating delivery status of parts that are stored in a database.

10. A program for causing a computer to execute procedures, the procedures comprising:
a procedure for acquiring part identification information indicating a required part, required quantity information indicating quantity of the required part, and required timing information indicating a time when the part is required; and
a procedure for selecting a securement site for securing the required part based on the part identification information, the required quantity information that were acquired, as well as on required timing information, and inventory status information indicating inventory status of the part and delivery status information indicating delivery status of parts that are stored in a database.
